(19) United States
(12) Patent Application Publication
(10) Pub. No.: US 2015/0250673 A1
(43) Pub. Date: Sep. 10, 2015

(54) DENTAL ABRADING TOOLS FOR STABILIZED USES

(71) Applicant: WASATCH CREST TECHNOLOGIES, LLC, Salt Lake City, UT (US)

(72) Inventors: Jesse N. Greaves, Salt Lake City, UT (US); Kevin E. Peterson, Salt Lake City, UT (US)

(21) Appl. No.: 14/441,164

(22) PCT Filed: Nov. 6, 2013
(86) PCT No.: PCT/US13/68773

§ 371 Date: May 6, 2015

Related U.S. Application Data
(60) Provisional application No. 61/723,263, filed on Nov. 6, 2012.

(51) Int. Cl. A61G 15/16; A61C 1/07; A61D 5/00; A61C 7/02; A61C 3/06

(52) U.S. Cl. CPC A61G 15/16; A61C 7/02; A61C 3/06; A61D 5/00; A61C 1/07

(57) ABSTRACT

A method of removing tooth structure includes applying an abrading implement to a first tooth by applying a first hand piece to the abrading implement with a shank that affixes the abrading implement. The abrading implement is moved against a tooth under conditions to remove tooth material from the tooth while erratic behavior is modified by use of a second hand piece that is configured to be held by a second hand. The second hand piece interfaces with the shank proximal to the location where the abrading implement is affixed.

### PRIORITY DATA

This application claims the benefit of U.S. Provisional Patent Application Ser. No. 61/723,263, filed on Nov. 6, 2012, which is incorporated herein by reference,

### TECHNICAL FIELD

Disclosed embodiments relate to abrading tools, for example dental abrading tools, and stabilized uses thereof.

### BRIEF DESCRIPTION OF THE DRAWINGS

Several embodiments are disclosed and selected embodiments thereof are illustrated. A more particular description of various embodiments briefly described above will be rendered by reference to the drawings. These drawings depict embodiments that are not necessarily drawn to scale and are not to be considered to be limiting in scope. Some embodiments will be described and explained with additional specificity and detail through the use of the accompanying drawings in which:

FIG. 1 is a perspective view of a dental abrading tool that is stabilized during use according to an example embodiment;

FIG. 2 is a side elevation of the dental abrading tool depicted in FIG. 1 according to an example embodiment;

FIG. 3 is a cross-section elevation of the dental-abrading tool depicted in FIG. 2 according to an example embodiment;

FIG. 4 is a cross-section detail elevation of a portion of the dental-abrading tool depicted in FIG. 3 according to an example embodiment;

FIG. 5 is a perspective view of a dental-abrading tool that is partially stabilized during use according to a comparative example embodiment;

FIG. 6 is a perspective view of a dental-abrading tool that is stabilized during use which shows relative lever-arm effects according to an example embodiment;

FIG. 7 is a perspective elevation of a dental-abrading tool according to an example embodiment;

FIG. 8 is a cross-section detail of the grinding wheel depicted in FIG. 7 according to an example embodiment;

FIG. 9 is a cross-section detail of the grinding wheel depicted in FIG. 7 according to an example embodiment;

FIG. 10 is a cross-section detail of the grinding wheel depicted in FIG. 7 according to an example embodiment;

FIG. 11 is an end elevation of a grinding wheel according to an example embodiment;

FIG. 12 is a cross-section elevation of a dental-abrading tool according to an example embodiment;

FIG. 13 is a side elevation of a dental-abrading toot a d a thimble stabilizer that is applied to the tool according to an example embodiment;

FIG. 14 is a cross-section elevation of a thimble stabilizer that is used with a dental-abrading tool according to an example embodiment;

FIG. 15 is a side elevation of a dental-abrading tool and a thimble stabilizer that is applied to the tool according to an example embodiment;

FIG. 16 is a cross-section elevation of the dental-abrading tool depicted in FIG. 15 according to an example embodiment;

FIG. 17 is an end elevation of a grinding oscillator according to an example embodiment;

FIG. 18 is a side elevation of a dental-abrading tool and a finger-sticker stabilizer that is applied to the tool according to an example embodiment;

FIG. 19 is a perspective view of a dental-abrading tool that is stabilized during use according to an example embodiment;

FIG. 20 is a perspective elevation of an orthodontic structure applied to a tooth according to an example embodiment;

FIG. 21 is a method flow according to an example embodiment;

FIG. 22 is grinder for structures other than dental tissues; and

FIG. 23 is an exploded perspective detail of a portion of a dental-abrading tool according to an example embodiment.

### DETAILED DESCRIPTION

Although the following detailed description contains many specifics for the purposes of illustration, a person of ordinary skill in the art will appreciate that many variations and alterations to the following details can be made and are considered to be included herein.

Accordingly, the following embodiments are set forth without any loss of generality to, and without imposing limitations upon, any claims set forth. It is also to be understood that the terminology used herein is for the purpose of describing particular embodiments only, and is not intended to be limiting. Unless defined otherwise, all technical and scientific terms used herein have the same meaning as commonly understood by one of ordinary skill in the art to which this disclosure belongs.

As used in this specification and the appended claims, the singular forms “a,” “an” and “the” include plural referents unless the context clearly dictates otherwise. Thus, for example, reference to “a layer” includes a plurality of such layers.

In this disclosure, “comprises,” “comprising,” “containing” and “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law, “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the compositions nature or characteristics would be permissible if present under the “consisting essentially of” language, even though not expressly recited in a list of items following such terminology. When using an open ended term, like “comprising” or “including,” it is understood that direct support should be afforded also to “consisting essentially of” language as well as “consisting of” language as if stated explicitly.

“The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments described herein are, for example, capable of operation in other orientations than those illustrated or otherwise described herein. Objects described herein as being “adjacent to” each other may be in physical contact with each other, in close proximity to each other, or in the same general region or area as each other, as appropriate for the context in which the phrase is used. Occurrences of the phrase “in one embodiment,” or “in one aspect,” herein do not necessarily all refer to the same embodiment or aspect.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually.

This same principle applies to ranges reciting only one numerical value as a minimum or a maximum. Furthermore, such an interpretation should apply regardless of the breadth of the range or the characteristics being described.

Reference throughout this specification to “an example” means that a particular feature, structure, or characteristic described in connection with the example is included in at least one embodiment. Thus, appearances of the phrases “in an example” in various places throughout this specification are not necessarily all referring to the same embodiment.

Abrading tools, including dental abrading tools are disclosed for dental and orthodontic uses.

Reference is made to the drawings wherein like structures may be provided with like reference-suffix designations. In order to show the dental tools of various embodiments most clearly, the drawings included herein are diagrammatic representations of dental tool embodiments and some of their use embodiments. Thus, the actual appearance of the dental-tool embodiments and their use embodiments may appear different while still incorporating the claimed dental tools of the illustrated embodiments as well as the claimed methods. Moreover, the drawings show only the structures necessary to understand the illustrated embodiments. Additional structures known in the art have not been included to maintain the clarity of the drawings.

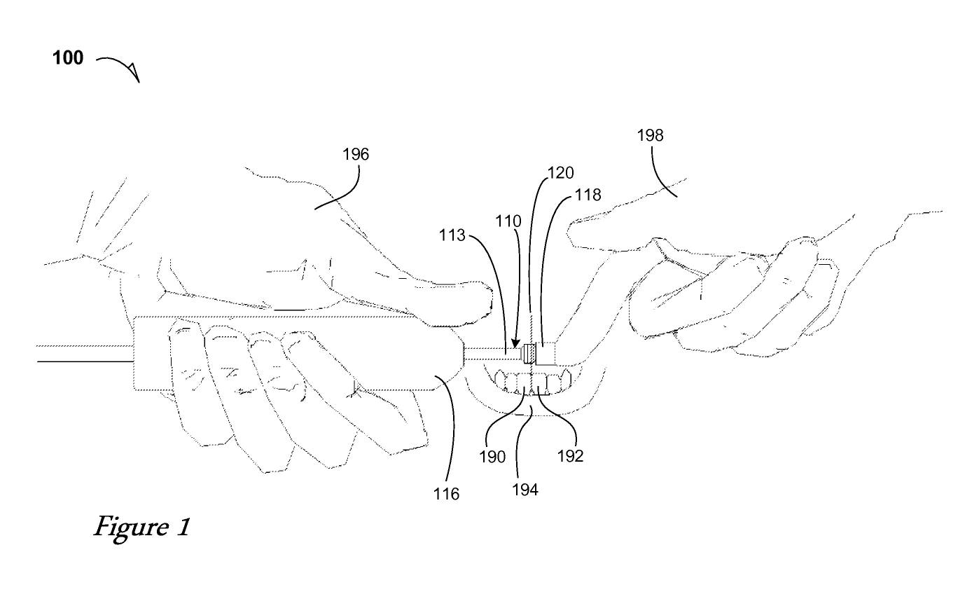

FIG. 1 is a perspective view of a dental-abrading tool that is stabilized during use 100 according to an example embodiment. A dental abrading tool 110 embodiment includes a shank 113 that is to be interfaced with a first hand piece 116. The dental abrading tool 110 also includes a second hand piece 118 that makes contact with structures affixed to the shank 113. An abrading implement 120 is located between the shank 113 and the second hand piece 118. As illustrated, the abrading implement 120 is a grinding wheel according to an embodiment. The second hand piece 118 may be referred to as a thimble 118.

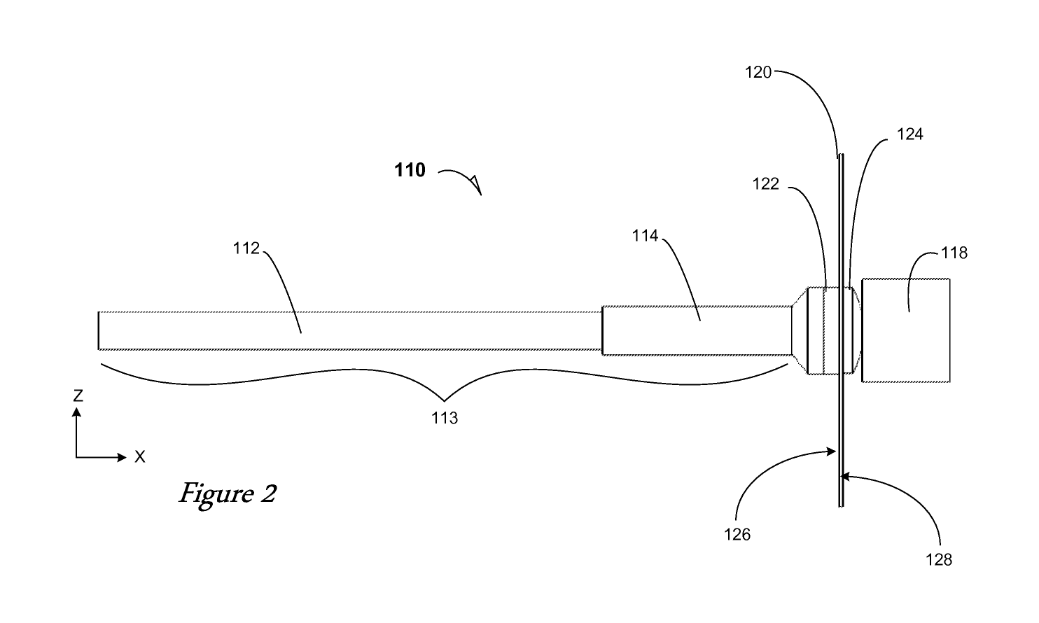

As depicted, the abrading implement 120 is affixed to the shank 113 by a first washer 122 (see FIG. 2) that is located on the same side of the abrading implement 120 as the shank 113. The abrading implement 120 is also affixed to a second washer 124 (see FIG. 2) that is located on the same side of the abrading implement 120 as the second hand piece 118.

Turning again to FIG. 1, an orthodontic or dental patient is illustrated in partial detail with a first tooth 190 and a second tooth 192 behind a lower tip 194. A dental worker is illustrated in partial detail with a first hand 196 that is holding the first hand piece 116 and a second hand 198 that is stabilizing the dental tool 110 with the index finger at the second hand piece 118.

The abrading implement 120 is depicted inserted between the first tooth 190 and the second tooth 192 during a dental interproximal reduction procedure according to an example embodiment. The dental interproximal reduction procedure is performed for removing tooth structure from one or both of the first tooth 190 and the second tooth 192, and the second hand 198 is adding useful stability at the second hand piece 118 while the dental worker receives power to the dental abrading tool 110 from a coupling such as an electrical drive, a pneumatic drive, or a mechanical drive. This procedure embodiment is useful such as in orthodontic or dental practice to uncrowd two adjacent teeth by removing some tooth structure at the interproximal contact point, but while adding useful stability and/or precision to the procedure by applying the second hand 198 to the second hand piece 118. For example, a grinding wheel 120 may have significant torque during operation that may cause the grinding wheel 120 to bind and cause unplanned tissue removal. Also, the grinding wheel may have erratic behavior that can be exhibited if just the first hand 196 is applied during a dental interproximal reduction procedure.

By using the first hand 196 on the first hand piece 116 and the second hand 198 on the second hand piece 118, the erratic behavior can be modified, minimized, or even eliminated. “Erratic behavior” is understood to be a motion or movement of the grinding implement 120 in a way or to a degree that removes, or risks removal of more or less material from an object upon which the grinding implement is used than is desired or intended by the user, or is useful for a given application or procedure. In some aspects, “erratic behavior” reduces precision and increases the possibility for error. In an example embodiment, a “useful procedure” is a dental interproximal reduction carried out in orthodontia by use of the procedure illustrated and described herein. Similarly, “erratic behavior” is understood to be motion of the grinding implement 120 under conditions that may remove tooth structure that is not useful to be removed. “Erratic behavior” may also be understood to be motion of the grinding implement 120 relative to the gingiva, tongue, and other tissues of the patient, excepting the tooth and that portion thereof to be removed. A rotating grinding implement has different drag-resistance reactions depending upon the portion of the grinding wheel 120 that is being applied to a tooth. For example, where the top of the grinding wheel 120 is rotating toward the dental professional and where the bottom of the grinding wheel is in contact with the tooth, the grinding wheel initially has a tendency to resist motion toward the patient.

It may now also be understood that “modifying erratic behavior” includes the application of the second hand at the second hand piece 118 under competent dental surgery conditions. Such competent dental surgery conditions include a legally appropriate dental professional applying a first hand at the first hand piece 116 and applying a second hand at the second hand piece 118.

FIG. 2 is a side elevation of the dental abrading tool 110 depicted in FIG. 1 according to an example embodiment. The shank 113 is further illustrated as a power-interface part 112 that interfaces with mechanical or pneumatic or electrical power and a chuck portion 114 of the shank 113 that interfaces with the abrading implement 120. A first washer 122 seats between the chuck portion 114 of the shank 113 and the abrading implement 120 at a first side 126. A second washer 124 seats between the second hand piece 118 and the abrading implement 120 at a second side 128. A location to affix the abrading implement is between the first washer 122 and the second washer 124.

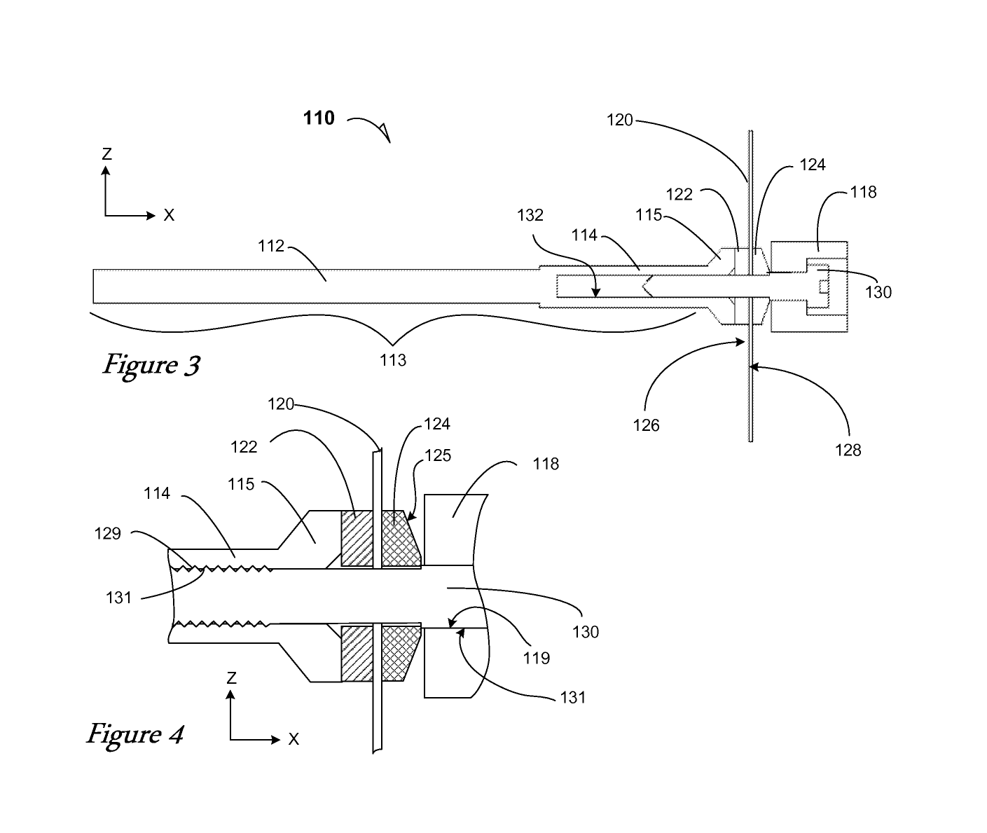

FIG. 3 is a cross-sectional elevation of the dental-abrading tool 110 depicted in FIG. 2 according to an example embodiment. The shank 113 is further illustrated in cross section with the power-interface part 112 and the chuck portion 114. The chuck portion 114 includes an inner channel 132 that is configured to receive a fastener 130. The fastener 130 may also be referred to as an interface for a second hand piece located on the shank proximal the location to affix the abrading implement. In this embodiment, the fastener 130 is an interface 130 for the second hand piece 118. Relative to the form factor of the shank 113, the fastener is located on the shank 113 proximal the location to affix the abrading implement 120.

A flange 115 expands from the chuck portion 114 to provide a seat for the first washer 122. The first washer 122 seats between the flange 115 and the abrading implement 120 at the first side 126. A second washer 124 rotatingly seats between the second hand piece 118 and the abrading implement 120 at a second side 128. The fastener 130 is depicted as a machine screw that may be threaded (see FIG. 4) in a manner that motion of the grinding implement 120 does not act to loosen the fastener 130. Accordingly, the second hand piece 118 is configured to couple at the interface 130. The second hand piece 118 may be referred to as a thimble 118 because of the general shape to accommodate a finger.

FIG. 4 is a cross-section detail elevation of a portion of the dental-abrading tool 110 depicted in FIG. 3 according to an example embodiment. The chuck portion 114 of the shank 113 is depicted with shank threads 129 that mate with fastener threads 131 on the fastener 130. The flange 115 expands from the chuck portion 114 to provide a seat for the first washer 122. The second washer 124 seats between the second hand piece 118 and the abrading implement 120 at the second side 128. The fastener 130 passes through the second hand piece 118, the second washer 124, the grinding implement 120, and the first washer 122 to attach with the fastener threads 131 within the inner channel 132.

In an embodiment, the second washer 124 has a beveled surface 125 that minimizes frictional contact between the second hand piece 118 and the second washer 124. A bearing surface 119 inside the second hand piece 118 allows the fastener 130 to rotate with minimal friction while the second hand 198 steadies operation of the abrading implement 120 during a dental abrading procedure by holding a digit such as the index finger of the second hand 198 firmly against the second hand piece 118. By the same token, a fastener bearing surface 131 allows the second hand piece 118 to rotate with minimal friction against the bearing surface 119 inside the second hand piece 118. Accordingly, the second hand piece 118 is rotatingly affixed to the shank 113.

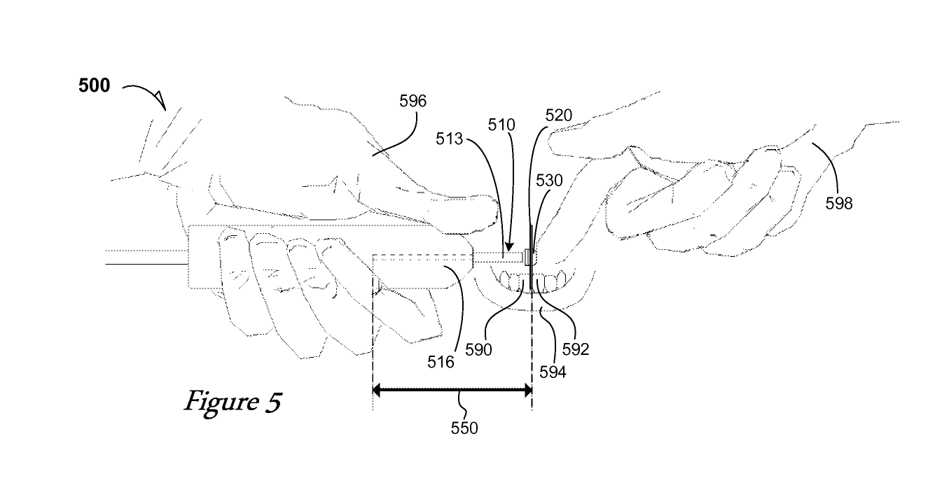

FIG. 5 is a perspective view of a dental-abrading tool that is partially stabilized during use 500 according to a comparative example embodiment. A dental abrading tool 510 embodiment includes a shank 513 that is to be interfaced with a first hand piece 516. An abrading implement 520 is located between the shank 513 a nut 530 that fastens the abrading implement to the shank 513. As illustrated, the abrading implement 520 is a grinding wheel 520.

An orthodontic or dental patient is illustrated in partial detail with a first tooth 590 and a second tooth 592 behind a lower lip 594. A dental worker is illustrated in partial detail with a first hand 596 that is holding the first hand piece 516 and a second hand 598 that is attempting to stabilize the dental tool 510 with the right index finger at the nut 530. The illustrated attempt to stabilize the dental tool includes modifying erratic behavior of the abrading implement 520 by use of a first hand holding the first hand piece 516 and a second hand at the nut 530.

The abrading implement 520 is depicted inserted between the first tooth 590 and the second tooth 592 during a dental interproximal reduction procedure according to an example embodiment. While this procedure embodiment is useful such as in orthodontic or dental practice to uncrowd two adjacent teeth by removing some tooth structure at the interproximal contact point, adding useful stability to the procedure by applying the second hand 598 to the nut 530 may be challenging unless the nut 530 may freely rotate, or a portion thereof against e.g., the index finger of the second hand 598.

In any event, a moment arm 550 is established between the dental interproximal insertion of the grinding implement 520 and the center of purchase of the first hand 596 upon the first hand piece 516. Although the dental professional may have a steady hand (including resting a finger fulcrum on the patient), the rotating action of the grinding implement 520 may present a challenge to have a stabile enough presentation of the grinding implement 520 against e.g. the second tooth 592 during a dental interproximal reduction procedure that achieves a useful amount of tooth reduction for a given orthodontic treatment element. The challenge includes erratic motion of the nut 530 against the finger.

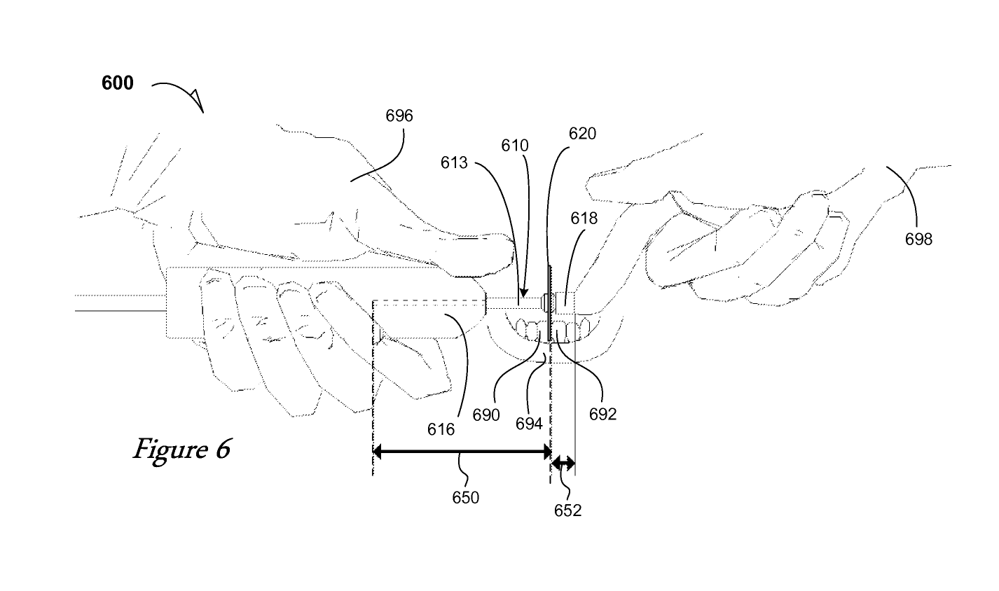

FIG. 6 is a perspective view of a dental-abrading tool that is stabilized during use 600 which shows relative lever-arm effects according to an example embodiment. A dental abrading tool 610 embodiment includes a shank 613 that is to be interfaced with a first hand piece 616. An abrading implement 620 is located between the shank 613 a second hand piece 618 that is fastened to the shank 613 along with first- and second washers (see, e.g. first- and second washers 122 and 124, respectively, in FIGS. 2, 3, and 4). As illustrated, the abrading implement 620 is a grinding wheel 620.

An orthodontic or dental patient is illustrated in detail with a first tooth 690 and a second tooth 692 behind a lower lip 694. A dental worker is illustrated in detail with a first hand 696 that is holding the first hand piece 616 and a second hand 698 that stabilizing the dental tool 610 with the right index finger at the second hand piece 618.

The abrading implement 620 is depicted inserted between the first tooth 690 and the second tooth 692 during a dental interproximal reduction procedure according to an example embodiment. This procedure embodiment is useful such as in orthodontic or dental practice to uncrowd two adjacent teeth by removing some tooth structure at the interproximal contact point because useful stability is added to the procedure by applying the second hand 698 to the second hand piece 618.

In any event, a moment arm 650 is established between the dental interproximal insertion of the grinding implement 620 and a center of purchase of the first hand 696 upon the first hand piece 616. Although the dental professional may have a steady hand (including resting the elbow of the first hand 696 upon an arm rest, etc.), the rotating action of the grinding implement 620 is further controlled and stabilized by pressing e.g. an index finger of the second hand 698 against the second hand piece 618 during presentation of the grinding implement 620 against, e.g. the second tooth 692 during a dental interproximal reduction procedure that achieves a useful amount of tooth reduction for a given orthodontic treatment element. A second moment arm 652 may also be established by the dental worker that counters in part the first moment arm 650 such that a stabilized dental operation is carried out.

As illustrated, stabilization of the dental tool includes modifying erratic behavior of the abrading implement 620 by use of a first hand holding the first hand piece 616 and a second hand holding the second hand piece 618 while it is freely rotating against the grinding implement.

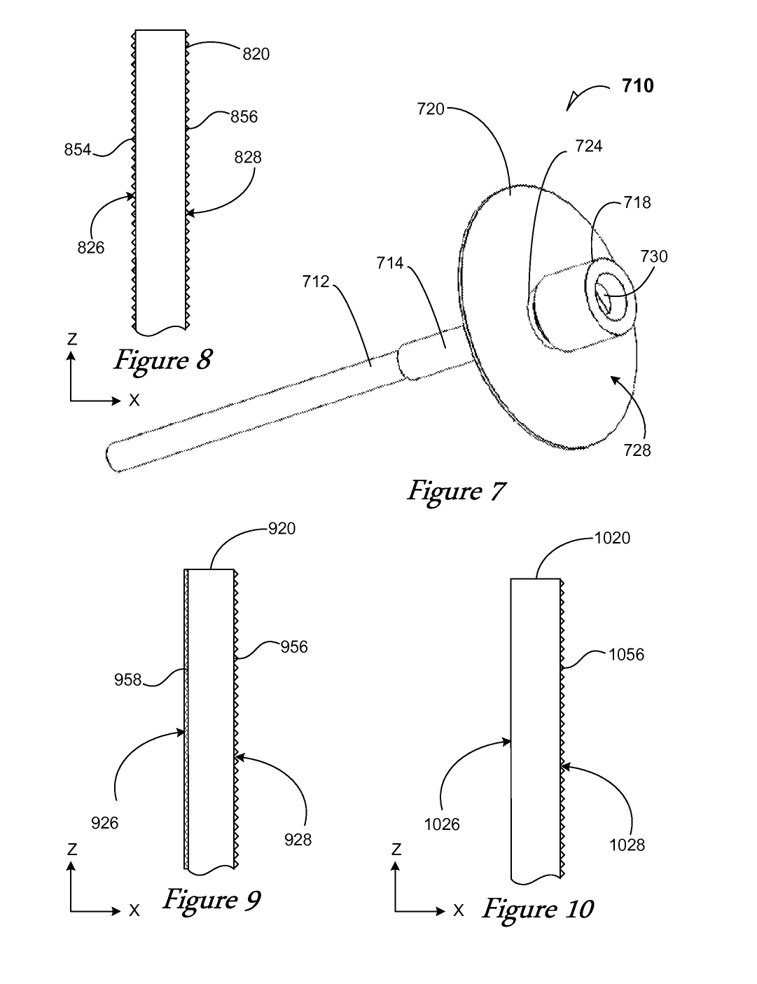

FIG. 7 is a perspective elevation of a dental-abrading tool 700 according to an example embodiment. A shank is illustrated as a power-interface part 112 that interfaces with mechanical or pneumatic or, electrical power, and a chuck portion 714 that interfaces with an abrading implement 720. A first washer (obscured by the abrading implement) seats between the chuck portion 714 of the shank and the abrading implement 720 at a first side (obscured by the abrading implement). A second washer 724 seats between a second hand piece 718 and the abrading implement 720 at a second side 728. A fastener 730 is seen from the end of the second hand piece 718. The fastener 730 is illustrated as a standard-head machine screw with specialized features such as that illustrated and described in FIGS. 1, 2, 3, and 4.

FIG. 8 is a cross-section detail of the grinding wheel depicted in FIG. 7 according to an example embodiment. A grinding wheel 820 that is to be affixed to a dental-abrading tool embodiment is shown in partial section such as a portion of the grinding wheel 120 depicted in FIG. 2 above (positive Z-direction) the shank 113. The grinding wheel 820 includes a first surface 826 that is analogous to the first side 126 of the grinding wheel 120 depicted in FIG. 1. A first grinding medium 854 is located on the first surface 826. The grinding wheel 820 includes a second surface 828 that is analogous to the second side 128 of the grinding wheel 120 depicted in FIG. 1. A second grinding medium 856 is located on the second surface 828.

In an embodiment, the first grinding medium 854 is the same in size and type as the second grinding medium 856. In this embodiment the grinding wheel 820 may be selected where the dental worker has determined to remove material from both the first tooth and the second tooth such as the first tooth 190 and the second tooth 192 depicted in FIG. 1.

In an embodiment, the first grinding medium 854 is different in type but similar in size as that of the second grinding medium 856. In this embodiment, the dental worker may determine to remove tooth structure from each of the first tooth and the second tooth, but the different grinding media types achieve different amounts of tooth structure removal.

In an embodiment, the first grinding medium 854 is different in both size and type as that of the second grinding medium 856. In this embodiment, the dental worker may determine to remove tooth structure from each of the first tooth and the second tooth, but the different grinding media types achieve different amounts of tooth structure removal.

In each of these embodiments depicted and described for FIG. 8, a stabilized procedure is carried out by applying the second hand 198 (see FIG. 1) to the second hand piece 118.

FIG. 9 is a cross-section detail of the grinding wheel depicted in FIG. 7 according to an example embodiment. A grinding wheel 920 that is to be affixed to a dental-abrading tool embodiment is shown in partial section such as a portion of the grinding wheel 120 depicted in FIG. 2 above (positive Z-direction) the shank 113. The grinding wheel 920 includes a first surface 926 that is analogous to the first side 126 of the grinding wheel 120 depicted in FIG. 1. A first friction-reducing medium 954 is located on the first surface 926. The grinding wheel 920 includes a second surface 928 that is analogous to the second side 128 of the grinding wheel 120 depicted in FIG. 1. A second grinding medium 956 is located on the second surface 928.

In an embodiment, the first friction-reducing medium 954 is a low-friction material such as Nylon® 612 that is manufactured by DuPont Chemical of Wilmington, Del. Other materials may be used that are based upon the polyamide chemistry upon which Nylon® is based. In this embodiment the grinding wheel 920 may be selected where the dental worker has determined to remove material from only the second tooth such as friction is significantly reduced upon the first tooth 190 and the second tooth 192 depicted in FIG. 1.

In an embodiment, the first friction-reducing medium 954 is a low-friction material such as Teflon® that is manufactured by DuPont Chemical of Wilmington, Del. Other materials may be used that are based upon the polytetrafluoroethylene chemistry upon which Teflon® is based. In this embodiment the grinding wheel 920 may be selected where the dental worker has determined to remove material from only the second tooth such as friction is significantly reduced upon the first tooth 190 and the second tooth 192 depicted in FIG. 1. In each of the embodiments depicted and described for FIG. 9, a stabilized procedure is carried out by applying the second hand 198 (see FIG. 1) to the second hand piece 118.

FIG. 10 is a cross-section detail of the grinding wheel depicted in FIG. 7 according to an example embodiment. A grinding wheel 1020 that is to be affixed to a dental-abrading tool embodiment is shown in partial section such as a portion of the grinding wheel 120 depicted in FIG. 2 above (positive Z-direction) the shank 113. The grinding wheel 1020 includes a first surface 1026 that is analogous to the first side 126 of the grinding wheel 120 depicted in FIG. 1. The grinding wheel 1020 includes a second surface 1028 that is analogous to the second side 128 of the grinding wheel 120 depicted in FIG. 1. A second grinding medium 1056 is located on the second surface 1028.

In an embodiment, the grinding wheel 1020 may be selected where the dental worker has determined to remove material from only the second tooth such as friction is significantly reduced upon the first tooth 190 and the second tooth 192 depicted in FIG. 1.

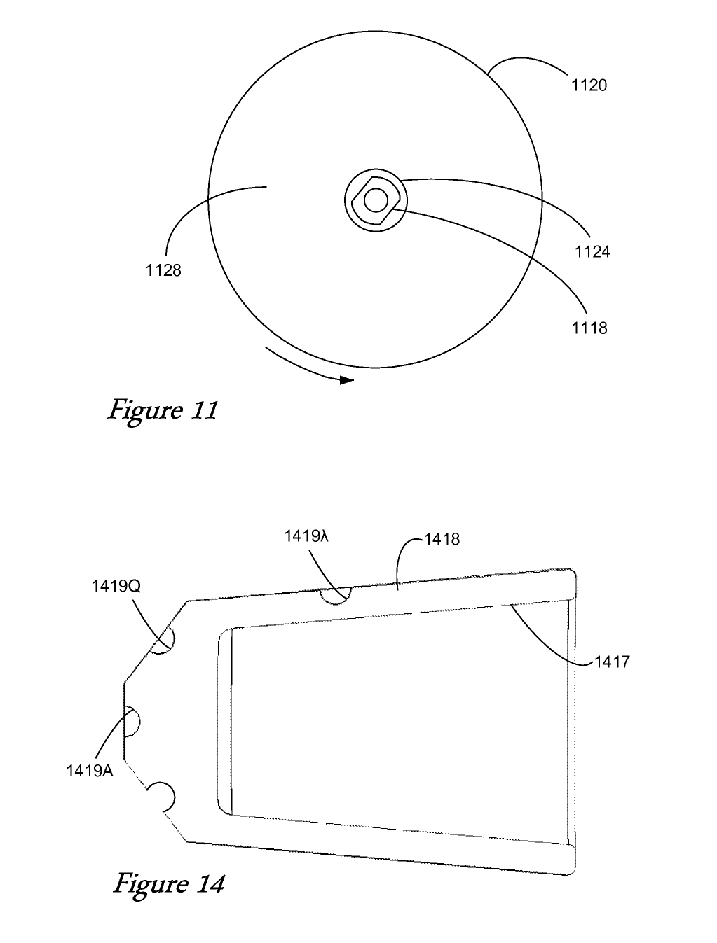

FIG. 11 is an end elevation of a grinding wheel 1120 according to an example embodiment. A second washer 1124 seats between a second hand piece 1118 and the abrading implement 1120 at a second side 1128. The abrading implement 1120 is operated in a continuous rotary motion.

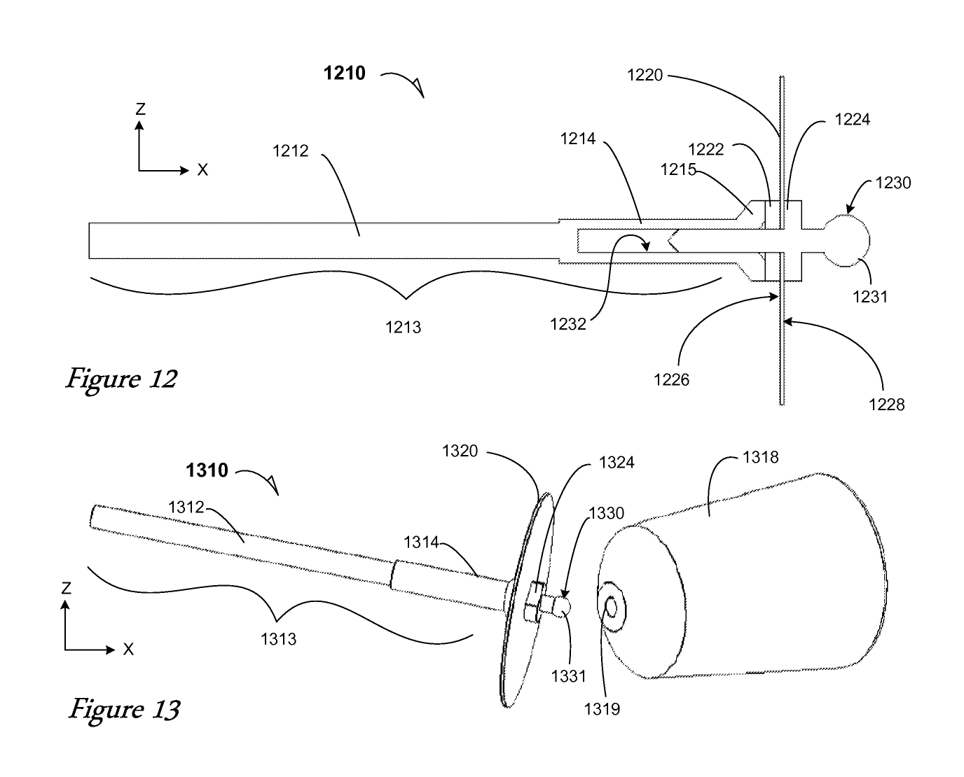

FIG. 12 is a cross-section elevation of a dental-abrading tool 1210 according to an example embodiment. A shank 1213 includes a power-coupling part 1212 and is further illustrated in cross section with a chuck portion 1214. A first washer 1222 seats between the chuck portion 1214 and an abrading implement 1220 at a first side 1226. A second washer 1224 is part of a fastener 1230 that extends into an inner channel 1232 of the chuck portion 1214 of the shank. A bearing surface 1331 is used with an independent implement that is a second hand piece (see, e.g., FIG. 13) for a method embodiment. The second washer 1224 portion of the fastener seats between the bearing surface 1319 and the abrading implement 1220 at a second side 1228.

A flange 1215 expands from the chuck portion 1214 to provide a seat for a first washer 1222. The first washer 1222 seats between the flange 1215 and the abrading implement 1220 at the first side 1226. The fastener 1230 is depicted as including a machine screw portion (see, e.g., FIG. 4) that may be threaded in a manner that motion of the grinding implement 1220 does not act to loosen the fastener 1230. However, it is to be understood that the fastener can take a variety of specific forms capable of engaging the inner channel 1232, such as a friction-fit pin, a rivet, and may be held in place by other permanent or semi-permanent mechanisms including without limitation, welding, anchoring, soldering, brazing, adhesive, etc. Further, the fastener 1330 may be hollow or solid, and in some aspects, the fastener may be an integral or continuous portion of the shank 1213.

According to one embodiment, the shank 1213 is configured for a first hand piece and a location to affix the abrading implement 1220 is between the first washer 1222 and the second washer 1224. Further, the fastener 1230 may also be referred to as an interface for a second hand piece located on the shank 1213 proximal the location to affix the abrading implement 1220. In this embodiment, the fastener 1230 includes an interface 1231 that is a bearing surface for a second hand piece such as the hand piece 1318 depicted in FIG. 13. Relative to the form factor of the shank 1213, the fastener 1230 is located on the shank 1213 proximal the location to affix the abrading implement 1220.

FIG. 13 is a perspective elevation of a dental-abrading tool 1310 and a thimble stabilizer 1318 that is applied to the tool 1310 according to an example embodiment. A shank 1313 includes a power-coupling part 1312 and is further illustrated with a chuck portion 1314. A first washer seats between the chuck portion 1314 and an abrading implement 1320 at a first side. A second washer 1324 is part of a fastener 1330 that extends into an inner channel of the chuck portion 1314. The second washer 1324 portion of the fastener 1330 seats between the bearing surface 1331 and the abrading implement 1320 at a second side 1328. Accordingly, the second hand piece 1318 is configured to be rotatingly coupled to the shank 1313.

A bearing surface 1319 is used with an independent implement that is a second hand piece 1318 for a method embodiment as depicted, the second hand piece 1318 is a thimble 1318 that fits over a digit of a dental worker such as on the index finger of the second hand 198 depicted in FIG. 1. In an embodiment, the thimble 1318 provides a more certain purchase on the finger of a dental worker than the second hand piece 118 depicted in FIG. 2. Further as depicted, the second hand piece as a thimble 1318 may allow the dental worker to angle the second hand piece 1318 out of the axis of the shank 1313 while still providing axial stability to the shank 1313 while the grinding implement 1320 is in motion.

According to this embodiment, the shank 1313 is configured for the first hand piece 1318 and a location to affix the abrading implement 1320 is between the first washer and the second washer 1324. Further, the fastener 1330 may also be referred to as an interface for a second hand piece located on the shank 1313 proximal the location to affix the abrading implement 1320. In this embodiment, the fastener 1330 includes an interface 1331 that is a bearing surface for the second hand piece 1318. Relative to the form factor of the shank 1313, the fastener 1330 is located on the shank 1313 proximal the location to affix the abrading implement 1320.

Consequently, the dental professional may modify, or minimize erratic behavior of the grinding implement 1320 by use of a first hand holding the first hand piece (that is to be affixed to the shank 1313) and by use of a second hand holding the second hand piece 1318 by applying the second hand piece bearing surface 1319 at the bearing surface 1331.

FIG. 14 is a cross-section elevation of a thimble stabilizer 1418 that is used with a dental-abrading tool according to an example embodiment. The thimble stabilizer 1418 includes a digit-insertion cavity 1417 for inserting a digit such as the index finger of the second hand 198 depicted in FIG. 1. It is understood the thimble stabilizer 1418 has a general thimble form factor.

In an embodiment, the thimble stabilizer 1418 is a second hand piece embodiment that provides an axial bearing surface 1419A similar to the axial bearing surface 1319 depicted for the second hand piece 1318 in FIG. 13. In a method embodiment, a dental worker inserts a digit from the second hand into the digit-insertion cavity 1417, and stabilizes a grinding implement by mating a bearing surface on the fastener with the axial bearing surface 1419A. In an example embodiment, the dental professional may modify erratic behavior of the grinding implement 1220, depicted in FIG. 12, by use of a first hand holding the first hand piece that is affixed to the shank 1213 and by use of a second hand holding the second hand piece by applying the second hand piece bearing surface 1419A at the bearing surface 1231. It is to be understood that the bearing surfaces 1419A. 1419Q, or 1419λ may take a variety of sizes and shapes that are complimentary to the bearing surface 1331 of the fastener 1330. Nearly any smooth and circular, semicircular, arcuate, or parabolic shape may be used. Likewise, the shape and size of the bearing surface 1331 of fastener 1330 may be of nearly any shape and size complimentary to the bearing surfaces 1419A. 1419Q, or 1419λ. Such complimentary shape allows for the bearing surfaces of 1419A. 1419Q, or 1419λ to be similar in size to, or larger than, the bearing surface 1331 of the fastener 1330 such that the bearing surface 1331 of the fastener 1330 can engage the bearing surfaces 1419A. 1419Q, or 1419λ.

In an embodiment, a quasi-axial bearing surface 1419Q is depicted upon the thimble 1418 on a facet of the thimble stabilizer 1418 that is near the axial bearing surface 1419A. In a method embodiment, a dental worker inserts a digit from the second hand into the digit-insertion cavity 1417, and stabilizes a grinding implement by mating a bearing surface of a fastener, such as the bearing surface 1331 of the fastener 1330 depicted in FIG. 13, with the quasi-axial bearing surface 1419Q in order to present the left hand toward the patient in a different attitude than when the axial bearing surface 1419A is used. In an example embodiment, the dental professional may modify erratic behavior of the grinding implement 1220, depicted in FIG. 12, by use of a first hand holding the first hand piece that is affixed to the shank 1213 and by use of a second hand holding the second hand piece by applying the second hand piece bearing surface 1419A at the bearing surface 1231.

In an embodiment, a lateral bearing surface 1419λ is depicted upon the thimble 1418 on a facet of the thimble stabilizer 1418. In a method embodiment, a dental worker inserts a digit from the second hand into the digit-insertion cavity 1417, and stabilizes a grinding implement by mating a bearing surface of a fastener, such as the bearing surface 1331 of the fastener 1330 depicted in FIG. 13, with the lateral bearing surface 1419λ in order to present the left hand toward the patient in a different attitude than when either the axial bearing surface 1419A or the quasi-axial bearing surface 1419Q are used. In an example embodiment, the dental professional may modify erratic behavior of the grinding implement 1220, depicted in FIG. 12, by use of a first hand holding the first hand piece that is affixed to the shank 1213 and by use of a second hand holding the second hand piece by applying the second hand piece bearing surface 1419λ at the bearing surface 1231.

It is to be understood that the intended point of engagement between the bearing surface 1331 of the fastener 1330 and the bearing surface 1419 (whether axial, quasi-axial, or lateral) of thimble 1418 may occur substantially at nearly any point deemed desirable and suitable to achieve a specifically intended result. For example, the point of engagement may be selected in order to accommodate use of the thimble 1418 on a digit of the right hand, a digit of the left hand, or ambidextrously (i.e. either right or left hand), or to allow the thimble 1418 to be held at a number of different orientations while engaging the fastener 1330, (e.g. facing head on, at an angle, or at a substantially 90 degree orientation, etc.). Moreover, multiple intended points of engagement can be specifically identified and placed to provide flexibility of use.

In a method embodiment, a dental worker uses at least two of the bearing surfaces 1419A, 1419Q, and 1419λ during a single dental interproximal reduction procedure.

In a dental operation embodiment, it is useful for the dental worker to have a variety of left-hand presentations for stabilizing a grinding implement embodiment, including using a combination of the three disclosed bearing surfaces of the thimble stabilizer 1418 during a single interproximal dental abrading procedure.

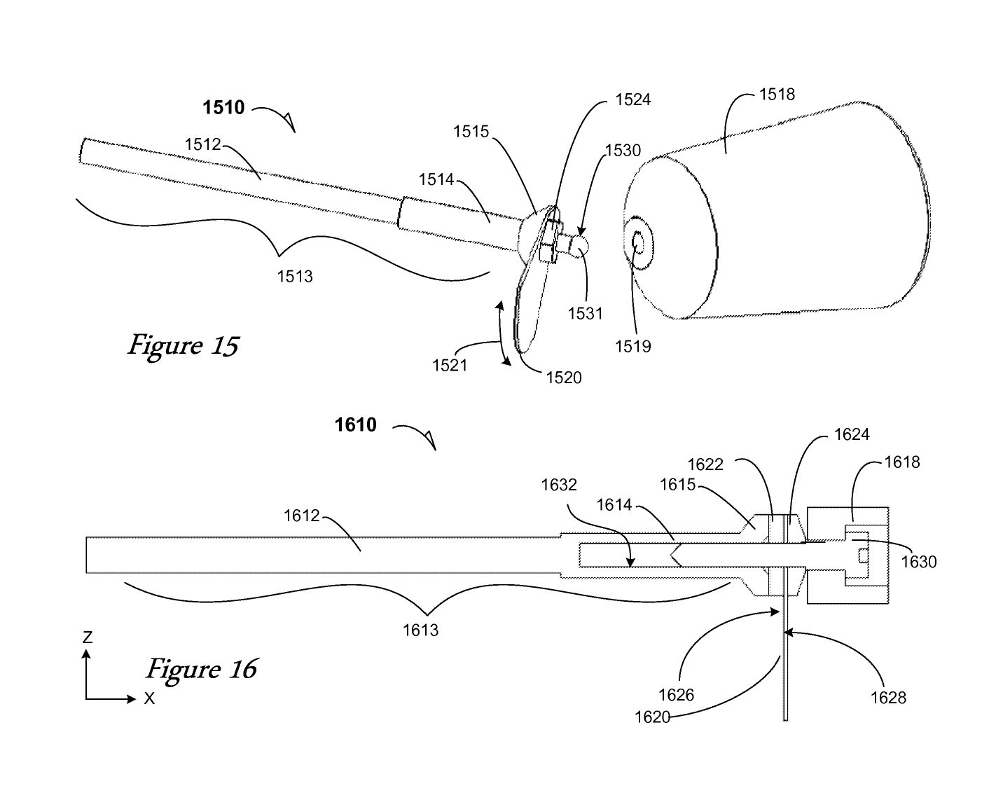

FIG. 15 is a perspective elevation of a dental-abrading tool 1510 and a thimble stabilizer 1518 that is applied to the tool according to an example embodiment. A shank 1513 includes a power-coupling part 1512 and is further illustrated with a chuck portion 1514. A first washer seats between the chuck portion 1514 and an abrading implement 1520 at a first side. A second washer 1524 is part of a fastener 1530 that extends into an inner channel of the chuck portion 1514. The second washer 1524 portion of the fastener 1530 seats between the bearing surface 1531 and the abrading implement 1520 at a second side 1528.

A bearing surface 1519 is used with an independent implement that is a second hand piece 1518 for a method embodiment as depicted, the second hand piece 1518 is a thimble 1518 that fits over a digit of a dental worker such as on the index finger of the second hand 198 depicted in FIG. 1. In an embodiment, the thimble 1518 provides a more certain purchase on the finger of a dental worker than the second hand piece 118 depicted in FIG. 2. Further as depicted, the second hand piece as a thimble 1518 may allow the dental worker to angle the second hand piece 1518 out of the axis of the shank 1513 while still providing axial stability to the shank 1513 while the grinding implement 1520 is in motion.

The grinding implement 1520 is used to perform dental interproximal reduction procedures by being moved in a radial oscillatory motion 1521 as opposed to a continuous rotary motion of the grinding implements 120, 520, 620, 720, 1120, 1220, and 1320. Consequently, the dental professional may modify erratic behavior of the grinding implement 1520 by use of a first hand holding the first hand piece (that is to be affixed to the shank 1513) and by use of a second hand holding the second hand piece 1518 by applying the second hand piece bearing surface 1519 at the bearing surface 1531.

It may now be appreciated that the grinding implements with the specialized surfaces seen in FIGS. 8, 9, and 10 may be applied to the grinding implement 1520 depicted in FIG. 15. Further, it may now be appreciated that the grinding implement 1520 may be assembled for use with any second hand piece depicted and described in this disclosure such as the second hand piece 118 or the second hand piece 1418 by way of non-limiting example embodiments.

FIG. 16 is a cross-section elevation of a dental-abrading tool according to an example embodiment. The dental-abrading tool 1610 is similar to the dental-abrading tool 310 depicted in FIG. 3 with the addition that a grinding implement 1620 is configured for radial-oscillatory grinding motion. A shank 1613 is illustrated in cross section with a power-interface part 1612 and a chuck portion 1614. The chuck portion 1614 includes an inner channel 1632 that is configured to receive a fastener 1630. A flange 1615 expands from the chuck portion 1614 to provide a seat for a first washer 1622. The first washer 1622 seats between the flange 1615 and the abrading implement 1620 at a first side 1626. A second washer 1624 seats between a second hand piece 1618 and the abrading implement 1620 at a second side 1628. The fastener 1630 is depicted as a machine screw that may be threaded similar to the fastener depicted in FIG. 4. The fastener 1630 is fastened in a manner that motion of the grinding implement 1620 does not act to loosen the fastener 1630. Consequently, the dental professional may modify, minimize, or substantially eliminate, erratic behavior of the grinding implement 1620 by use of a first hand holding the first hand piece (that is to be affixed to the shank 1613) and by use of a second hand holding the second hand piece 1618.

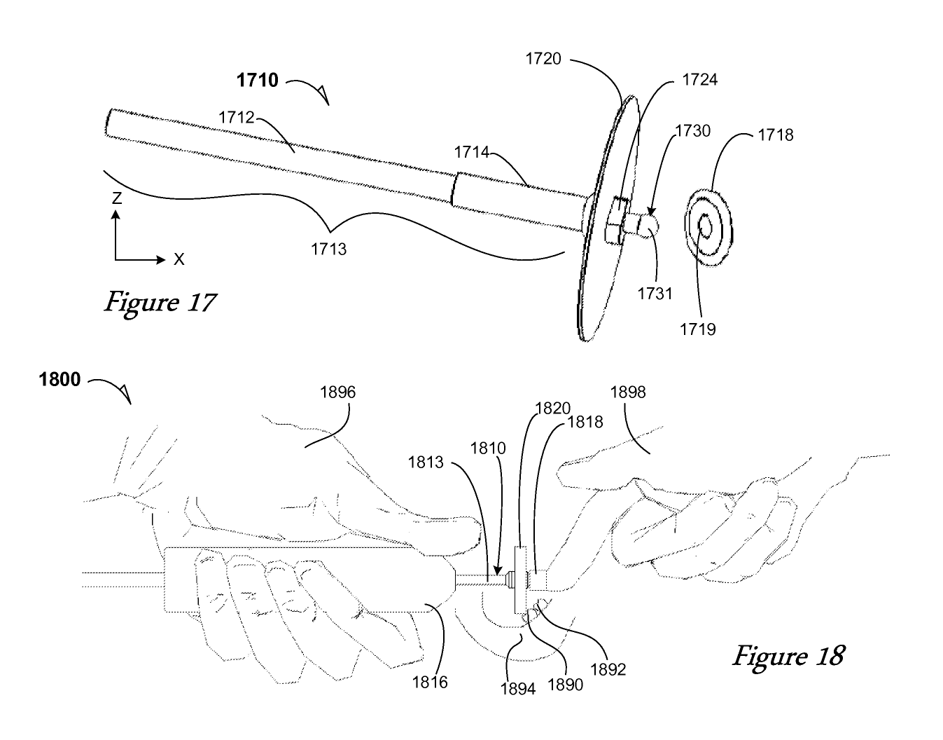

FIG. 17 is a side elevation of a dental-abrading tool 1710 and a finger-tip sticker 1718 stabilizer that is applied to the tool according to an example embodiment. A shank 1713 includes a power-coupling part 1712 and is further illustrated with a chuck portion 1714. A first washer seats between the chuck portion 1714 and an abrading implement 1720 at a first side. A second washer 1724 is part of a fastener 1730 that extends into an inner channel of the chuck portion 1714. The second washer 1724 portion of the fastener 1730 seats between the bearing surface 1731 and the abrading implement 1720 at a second side 1728.

A bearing surface 1719 is used with an independent implement that is a second hand piece 1718 for a method embodiment as depicted, the second hand piece 1718 is a finger-tip sticker 1718 that fits at the end of a digit of a dental worker such as on the tip of the index finger of the second hand 198 depicted in FIG. 1. In an embodiment, the finger-tip sticker 1718 provides a more certain purchase on the finger of a dental worker than the second hand piece 118 depicted in FIG. 2. Further as depicted, the finger-tip sticker 1718 may allow the dental worker to angle the second hand piece 1718 out of the axis of the shank 1713 while still providing axial stability to the shank 1713 while the grinding implement 1720 is in motion. It is understood the stabilizer 1718 has a general dish or finger-tip form factor in contrast to the thimble form factor of stabilizer 1418 depicted in FIG. 14.

According to this embodiment, the shank 1713 is configured for a first hand piece and a location to affix the abrading implement 1720 is between the first washer and the second washer 1724. Further, the fastener 1730 may also be referred to as an interface for the second hand piece 1718 located on the shank 1713 proximal the location to affix the abrading implement 1720. In this embodiment, the fastener 1730 includes an interface 1731 that is a bearing surface for the second hand piece 1718. Relative to the form factor of the shank 1713, the fastener 1730 is located on the shank 1713 proximal the location to affix the abrading implement 1720.

Consequently, the dental professional may modify, minimize, or substantially eliminate, erratic behavior of the grinding implement 1720 by use of a first hand holding the first hand piece (that is to be affixed to the shank 1713) and by use of a second hand holding the second hand piece 1718 by applying the second hand piece bearing surface 1719 at the bearing surface 1731.

It may now be appreciated that a radial-oscillatory grinding implement such as the grinding implement 1520 may be used along with a finger-tip sticker second hand piece 1718. Alternatively, other mechanisms of placing an effective barrier between a user's digit and the bearing surface 1731 of the fastener 1730 which allows the fastener to be held comfortably in place are contemplated as within the scope of the present invention.

FIG. 18 is a perspective view of a dental-polishing tool 1810 that is stabilized during use 1800 according to an example embodiment. A dental polishing tool 1810 embodiment includes a shank 1813 that is to be interfaced with a first hand piece 1816. The dental polishing tool 1810 also includes a second hand piece 1818 that makes contact with structures affixed to the shank 1813. A polishing implement 1820 is located between the shank 1813 and the second hand piece 1818. As illustrated, the polishing implement 1820 is a buffing wheel 1820 according to an embodiment.

The polishing implement 1820 is affixed to the shank 1813 by a first washer that is located on the same side of the polishing implement 1820 as the shank 1813. The polishing implement 1820 is also affixed to a second washer that is located on the same side of the polishing implement 1820 as the second hand piece 1818.

A dental patient is illustrated in partial detail with a first tooth 1890 and a second tooth 1892 behind a lower lip 1894. A dental worker is illustrated in partial detail with a first hand 1896 that is holding the first hand piece 1816 and a second hand 1898 that is stabilizing the dental tool 1810 with the right index finger at the second hand piece 1818.

During a polishing procedure performed upon one of the first tooth 1890 and the second tooth 1892, and the second hand 1898 is adding useful stability at the second hand piece 1818 while the dental worker receives power to the dental polishing tool 1810 from a coupling such as an electrical drive, a pneumatic drive, or a mechanical drive. This procedure embodiment is useful such as in dental practice to buff or micro-grind a tooth surface removing some tooth structure at the occlusal contact point, but while adding useful stability to the procedure by applying the second hand 1898 to the second hand piece 1818. Consequently, the dental professional may modify, minimize, or substantially eliminate, erratic behavior of the polishing implement 1820 by use of a first hand holding the first hand piece 1816 and by use of a second hand holding the second hand piece 1818.

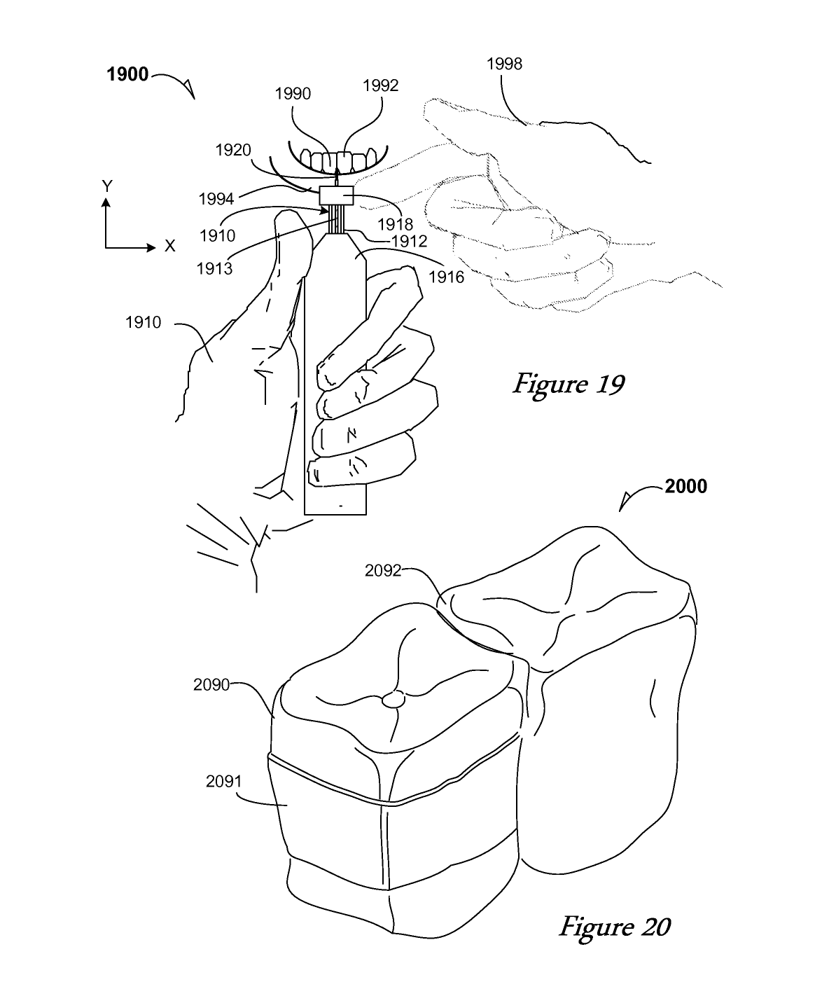

FIG. 19 is a perspective view of a dental-abrading tool that is stabilized during use 1900 according to an example embodiment. A dental abrading tool 1910 embodiment includes a reciprocating shank 1913 that is interfaced with a first hand piece 1916. The dental abrading tool 1910 also includes a second hand piece 1918 that makes contact with structures affixed to the reciprocating shank 1913. An abrading implement 1920 is affixed to the reciprocating shank 1913 and the second hand piece 1918 is slidingly coupled to the reciprocating shank 1913. Two stators 1912 couple the first hand piece 1916 to the second hand piece and the reciprocating shank also couple to the second hand piece 1918. The second hand piece 1918 may be referred to as a finger-tip stabilizer 1918.

The abrading implement 1920 is an abrasive blade. Embodiments of the abrading implement may be viewed in FIGS. 8, 9, and 10 except the coordinates are Y-X and the abrading implements 820, 920, and 1020 are presented in top plan view.

An orthodontic or dental patient is illustrated in partial detail with a first tooth 1990 and a second tooth 1992 behind a lower lip 1994. A dental worker is illustrated in partial detail with a first hand 1996 that is holding the first hand piece 1916 and a second hand 1998 that is stabilizing the dental tool 1910 with the right index finger at the second hand piece 1918.

The abrading implement 1920 is depicted inserted between the first tooth 1990 and the second tooth 1992 during a dental interproximal reduction procedure according to an example embodiment. The dental interproximal reduction procedure is performed for removing tooth structure from one of the first tooth 1990 and the second tooth 1992, and the second hand 1998 is adding useful stability at the second hand piece 1918 while the dental worker receives power to the dental abrading tool 1910 from a coupling such as an electrical drive, a pneumatic drive, or a mechanical drive. This procedure embodiment is useful such as in orthodontic practice to uncrowd two adjacent teeth by removing some tooth structure at the interproximal contact point, but while adding useful stability to the procedure by applying the second hand 1998 to the second hand piece 1918. For example, a grinding wheel 1920 may have significant torque during operation that may cause the grinding wheel 1920 to bind and cause unplanned tissue removal. Also, the grinding wheel may have erratic behavior that can be exhibited if just the first hand 1996 is applied during a dental interproximal reduction procedure. By using the first hand 1996 on the first hand piece 1916 and the second hand 1998 on the second hand piece 1918, the erratic behavior can be modified or even eliminated.

According to this embodiment, the shank 1913 is configured for the first hand piece 1918 and a location to affix the abrading implement 1920 is at one end of the shank. The abrading implement may also be described as proximate the interface 1912 for the second hand piece 1918 located on the shank 1913 proximal the location to affix the abrading implement 1920. Relative to the form factor of the shank 1913, the stators 1912 are located on the shank 1913 proximal the location to affix the abrading implement 1920.

Consequently, the dental professional may modify, minimize, or substantially eliminate, erratic behavior of the polishing implement 1920 by use of a first hand holding the first hand piece 1916 and by use of a second hand holding the second hand piece 1918.

FIG. 20 is a perspective elevation 2000 of an orthodontic structure applied to a tooth according to an example embodiment. A first animal tooth 2090 and a second tooth 2092 are depicted. A method embodiment has been carried out to achieve an interproximal dental reduction on the first tooth 2090.

After causing the abrading implement to move against a first tooth 2090 under conditions to remove tooth material from the first tooth 2090 and after modifying erratic behavior of the abrading implement by stabilizing at the second hand piece, the dental professional affixes an orthodontic appliance 2091 to the first tooth. In an embodiment, the orthodontic appliance 2091 is affixed adjacent an interproximal reduction that was achieved. It is understood that the illustrated orthodontic appliance 2091 is a non-limiting example embodiment.

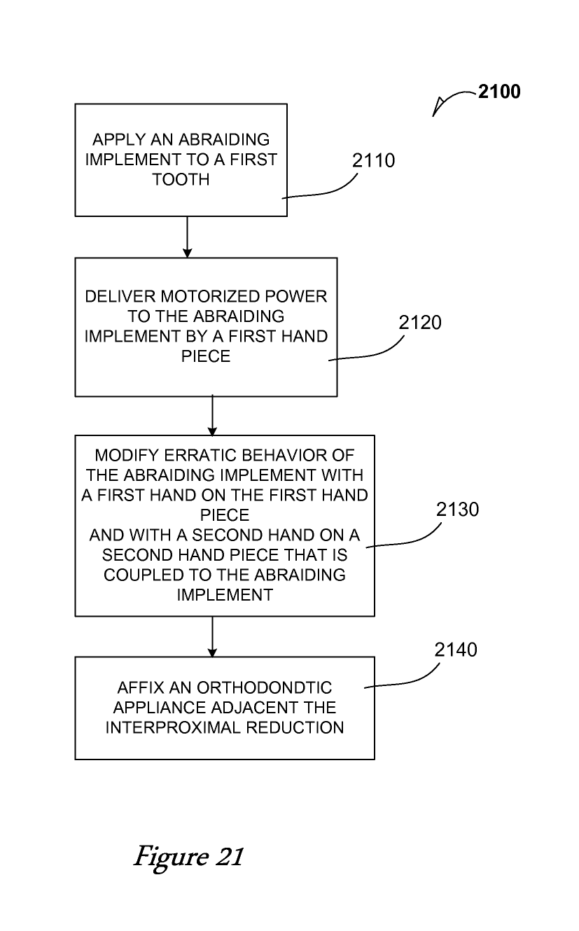

FIG. 21 is a method flow diagram 2100 according to example embodiments.

At 2110, the method includes applying an abrading implement to a first tooth. In a non-limiting example embodiment, a grinding wheel 120 is applied interproximally between a first tooth 190 and a second tooth 192. A grinding medium is in contact with the second tooth on the second side of the grinding wheel 120, but no grinding medium is in contact with the first tooth on the first side.

At 2120, the method includes delivering motorized power to the abrading implement by a first hand piece. This method element may also be understood as causing the abrading implement to move against the first tooth under conditions to remove tooth material from the first tooth. In a non-limiting example embodiment, a first hand piece 116 delivers rotary motion to a shank 113 to which the grinding wheel 120 is affixed.

At 2130, the method includes modifying erratic behavior of the abrading implement by applying a second hand to a second hand piece that is coupled to the abrading implement. In a non-limiting example embodiment, the abrading implement 120 is steadied by applying a hand at the second hand piece 118.

At 2140, the method includes affixing an orthodontic appliance to the first tooth. In a non-limiting example embodiment, an orthodontic band 2091 is applied to a first tooth 2090.

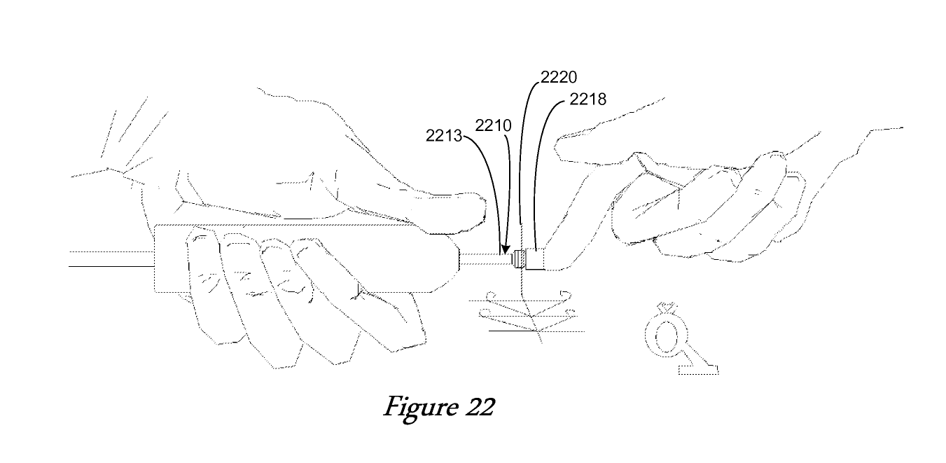

FIG. 22 is grinder for structures other than dental tissues. It may be appreciated that a stabilizer 2218 on an abrading implement may be used for operations such as jewelry.

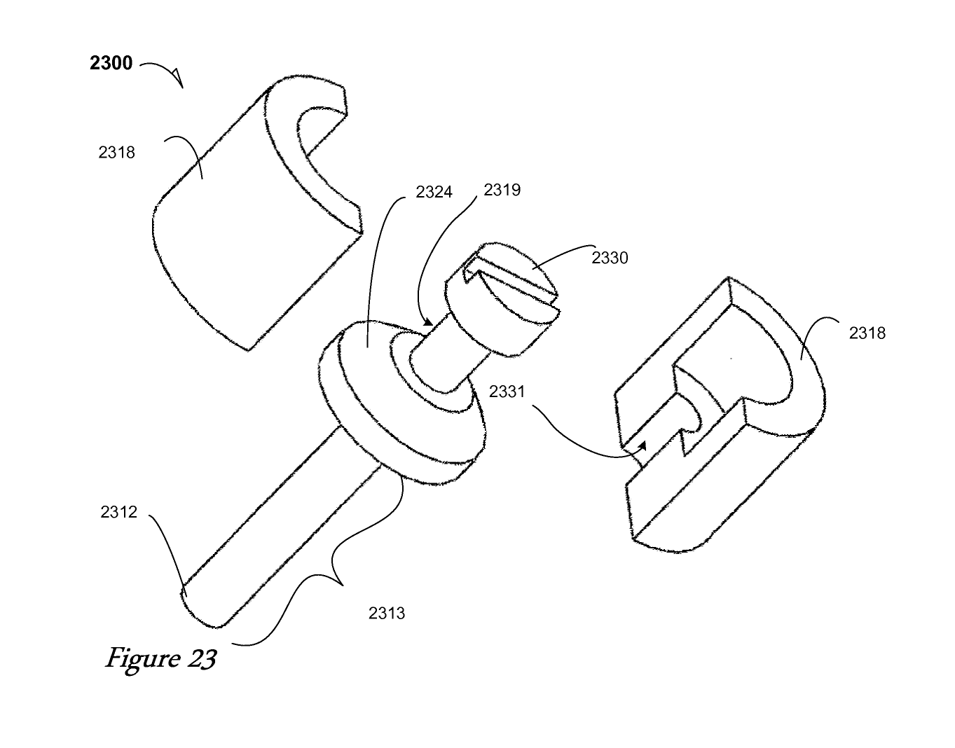

FIG. 23 is an exploded perspective detail of a portion of a dental-abrading tool according to an example embodiment. The shank 2313 is depicted with power interface part 2312 at one end and the fastener 2330 at the other end. The second hand piece 2318 is split and may be assembled by an adhesive around the fastener 2330. The second washer 2324 seats against the second hand piece 2318. The fastener 2330 passes through the second hand piece 2318.

In an embodiment, the second washer 2324 has a beveled surface. A bearing surface 2319 inside the second hand piece 2318 allows the fastener 2330 to rotate with minimal friction while the second hand of a dental professional may steady operation of the abrading implement during a dental abrading procedure. By the same token, a fastener bearing surface 2331 allows the second hand piece 2318 to rotate with minimal friction against the bearing surface 2319 inside the second hand piece 2318. Accordingly, the second hand piece 2318 is rotatingly affixed to the shank 2313.

In other aspects of the present invention, systems for performing dental procedures and/or dental surgeries are provided. Such systems can include one or more of the tools recited herein in combination with one or more of the second hand pieces recited herein.

1. A method of removing tooth structure comprising:
applying an abrading implement to a first tooth, wherein the abrading implement includes a first side and a second side, and wherein the abrading implement is affixed to a shank that is to interface with a first-hand piece, and wherein the first hand piece is configured to be held by a first hand;
causing the abrading implement to move against the first tooth under conditions to remove tooth material from the first tooth; and
modifying erratic behavior of the abrading implement at a second hand piece that is configured to be held by a second hand, wherein the first hand piece is disposed at the first side, and wherein the second hand piece is configured to be disposed at the second side.

2. The method of claim 1, further including affixing an orthodontic appliance to the first tooth.

3. The method of claim 1, wherein the abrading implement is a grinding wheel and wherein modifying erratic behavior is done by applying the second hand to the second hand piece, wherein the second hand piece is rotatingly affixed to the shank.

4. The method of claim 1, wherein the abrading implement is a grinding wheel and wherein modifying erratic behavior is done by applying the second hand to the second hand piece, wherein the second hand piece is configured to be rotatingly coupled to the shank.

5. The method of claim 1, wherein causing the abrading implement to move against the first tooth includes using a radial oscillatory motion, and wherein modifying erratic behavior is done by applying the second hand to the second hand piece, wherein the second hand piece is rotatingly affixed to the shank.

6. The method of claim 1, wherein causing the abrading implement to move against the first tooth includes using a radial oscillatory motion, and wherein the second hand piece is configured to be rotatingly coupled to the shank.

7. (canceled)

8. The method of claim 1, further including applying the abrading implement simultaneously to a second tooth adjacent the first tooth, and wherein causing the abrading implement to move against the first tooth under conditions to remove tooth material from the first tooth also causes the abrading implement to remove tooth material from the second tooth.

9. The method of claim 1, wherein the second hand piece includes a thimble form factor, and wherein causing the abrading implement to move against the first tooth includes stabilizing the abrading implement with at least one of a variety of left-hand presentations.

10. The method of claim 1, wherein the second hand piece includes a dish form factor, and wherein causing the abrading implement to move against the first tooth includes stabilizing the abrading implement with at least one of a variety of left-hand presentations.

11. A dental surgery system comprising:
a coupling for a first hand piece including a shank and a location to affix an abrading implement;
an interface for a second hand piece located on the shank proximal the location to affix the abrading implement; and
a second hand piece configured to couple at the interface for the second hand piece.

12. The dental surgery system of claim 11, wherein the second hand piece is affixed to the interface for the second hand piece.

13. The dental surgery system of claim 11, wherein the second hand piece is coupled to the interface for the second hand piece.

14. The dental surgery system of claim 11, wherein the second hand piece is a thimble stabilizer to be coupled to the interface for the second hand piece.

15. The dental surgery system of claim 11, wherein the second hand piece is a finger-sticker stabilizer to be coupled to the interface for the second hand piece.

16. The dental surgery system of claim 11, wherein the abrading implement includes a grinding wheel including a grinding medium affixed to at least one side of the grinding wheel.

17. The dental surgery system of claim 11, wherein the abrading implement includes a grinding wheel including a grinding medium affixed to one side of the grinding wheel and a first friction-reducing medium affixed to the other side of the grinding wheel.

18. The dental surgery system of claim 11, wherein the abrading implement includes a structure configured for radial oscillatory motion and that includes a grinding medium affixed to at least one side of the structure.

19. (canceled)

20. A dental surgery system comprising:
a coupling for a first hand piece including a shank and a location to affix the abrading implement, wherein the shank is configured with a power-interface part;
a firsthand piece configured for interfacing with the coupling;
an abrading implement affixed at the location to affix the abrading implement, wherein the abrading implement includes grinding media for removing tooth structure;
an interface for a second hand piece located on the shank proximal the location to affix the abrading implement;
a second hand piece configured to couple at the interface for the second hand piece, wherein the second hand piece is selected from the group consisting of a thimble stabilizer and a finger-tip stabilizer; and
an orthodontic appliance configured to be affixed to an animal tooth.

21. An abrasion device comprising:
a coupling for a first hand piece including a shank and a location to affix an abrading implement;
an interface for a second hand piece located on the shank proximal the location to affix the abrading implement; and
a second hand piece configured to couple at the interface for the second hand piece;
wherein use of the device in removal of material from a work piece modifying erratic behavior during the material removal.

22. The abrasive device of claim 21, wherein the second hand piece is rotatably affixed to the shank.

23. The abrasive device of claim 22, wherein the second hand piece is permanently affixed to the shank.

24. The abrasive device of claim 22, wherein the second hand piece is removably affixed to the shank.

25. The abrasive device of claim 21, wherein the abrading implement is a grinding wheel.

26. The abrasive device of claim 21, wherein modifying erratic behavior includes engagement of the second hand piece with a portion of the hand of a user.
